(19) United States
(12) Patent Application Publication
(10) Pub. No.: US 2003/0054826 A1
(43) Pub. Date: Mar. 20, 2003

(54) Delivery of an incoming data call from a public switched telephone network to a mobile station

(76) Inventors: Pietro Fionda, St-Leonard (CA); Leyla Kinaze, Kirkland (CA); Teresa Marchut-Wierzbica, Dorval (CA); Francis Simo, St. Leonard (CA)

Correspondence Address: SANDRA BEAUCHESNE, Ericsson Canada Inc., Patent Department (LMC/UP), 8400 Decarie Blvd., Town Mount Royal, QC, H4P 2N2, CA

(21) Appl. No.: 09/953,935

(22) Filed: Sep. 18, 2001

(51) Int. Cl. H04Q 7/20

(52) U.S. Cl. 455/445; 455/458; 455/432

(57) ABSTRACT

The present invention relates to a method for delivering an incoming data call from a Public Switched Telephone Network (PSTN) to a Mobile Station (MS). A Mobile Switching Center (MSC) first receives an incoming call and initiates a call setup procedure with an Interworking Function (IWF). The IWF adapts the data call for a cellular network and completes the call setup procedure with the MSC. The MSC then initiates a connection with a Base Station Controller (BSC) currently serving the MS. After the connection is completed, the PSTN is informed and data transfer with the MS can is initiated.

### BACKGROUND OF THE INVENTION

1. Field of the Invention

This invention relates to data call handling in a telecommunication system and, more precisely, to the delivery of data calls from a circuit switched network to a mobile station.

2. Description of the Related Art

In a telecommunication system, interconnection between two devices is provided for voice or data exchange. This interconnection uses resources in the system. Different types of communication schemes are used, depending on the network and on communication needs. The two common methods for providing interconnection are circuit switching and packet switching. They both occur on networks with various interconnected nodes.

Circuit switching involves reservation and usage of physical resources through the network between the communicating devices. In other words, a communication using circuit switching seizes a path of resources from node to node for all the duration of a call. This seizure is not influenced by the lack of use or the type of communication on the link. A circuit switching network has a limited number of available physical links than can be used at once.

Packet switching involves encapsulation of digital information in a predefined structure. The relevant information to be exchanged comes from a digital source or a digitized analog source. Each packet is built from this relevant information and from other parameters including address of destination. The packet is then sent on the network and routed between nodes according to the addressing information until it reaches its destination. In this scheme, resources are used by one packet on one link between two nodes for the duration of transmission of this packet only. The number of packets that can be sent simultaneously is limited by the bandwidth, i.e. the number of bits per second that the network infrastructure is able to support.

Because the two switching methods are structurally different in nature, a communication going through a first network using a first switching method to a second network using a second switching method requires some adaptation. This adaptation takes place at an interface node between the two networks. For adapting from a first switching method to another one, the following communication considerations must be taken into account: encapsulation and addressing, reordering and packet disassembly, error detection and correction, buffering and padding. Other adjustments can be necessary depending on the exact configuration of each node involved in the communication.

Encapsulation and addressing is done before sending on a packet switching link. The data is split according to the packet size and sent with appropriate addressing information. The data rate of the source added to the packet structural information should not be higher than the available bandwidth on the packet switching link otherwise some data would be dropped. These considerations apply to the adaptation from circuit switching to packet switching.

Reordering and packet disassembly is done when packets are received from a packet switching link. Because the packets are routed individually, they do not necessarily arrive in sequence. Therefore, they must be reordered in sequence before being disassembled. Packet disassembly is the opposite of encapsulation. More specifically, all the packet structural information is separated from the relevant information. The addressing information contained in the packet structural information is used to choose the correct circuit switching link to the corresponding destination. The relevant information is then sent on the circuit switching link.

Error detection and correction is done during the reception of data on either a circuit switching or packet switching link. The data must be encoded properly in order to this adaptation to take place. Error detection and correction consists mainly of using some of the data received to verify its integrity and, depending on the encoding scheme used, to correct the errors found.

Buffering and padding are mechanisms that ensure that the data rate on the circuit switching link is maintained at a constant level. Padding adds extra data on the circuit switching link if the packet switching data rate is not sufficient for the link rate. If the packet switching data rate is too high for the circuit switching data rate, buffering can store a limited amount of information from the packet switching link to be sent on the circuit switching link.

There are a wide variety of networks that use one of the presented switching methods. The most common example of circuit switching network is the Public Switched Telephone Network (PSTN). It is used in telephony to handle phone calls of different natures (data, voice, fax) between fixed subscribers. This is the most widespread network throughout the world.

Linking two networks using the same switching method can also involve some adaptation. An example of such adaptation is data rate adjustment between a PSTN link rate and a cellular network air interface rate.

Reference is now made to FIG. 1 presenting a signal flow chart of a terminating data call delivery in accordance with a prior art method. The method presented in the figure conforms to IS-658 standard from Telecommunications Industry Association (TIA).

A cellular network 100 comprises a Mobile Switching Center (MSC) 110, an Interworking Function (IWF) 120, a Base Station Controller (BSC) 130 and a Mobile Station (MS) 135. The MSC 110 acts as an entry point from the PSTN 140 to the cellular network 100. The IWF 120 is used for treating data calls incoming from the PSTN 140. The IWF 120 takes care of the different considerations of joining a circuit switching data communication from the PSTN to the cellular network. The BSC 130, in turn, controls a Base Station (BS) (not shown) which handles the radio communication with the Mobile Station (MS) 135. It should be noted that only one BSC 130, one MS 135 and one MSC 110 have been shown for clarity reasons, but the cellular network 100 usually comprises several such nodes.

The delivery of a data call 150 from the PSTN 140 to the MS 135 involves several steps. The MSC 110 first receives the data call 150 from the PSTN. Then, the MSC 110 negotiates radio resources for the MS 135. For doing so, the MSC 110, among other things, sends a paging request 152 to the BSC 130 currently serving the MS 135. On reception of the page request 152, the BSC 130 sends a paging request 153 to the MS 135 and waits for the MS 135 to send back a paging response 154. A paging response 155 is then sent by the BSC 130 to the MSC 110. The page response 155 signals the MSC 110 that the MS 135 was located and is ready for the connection of the call. Thus, the MSC 110 sends an assignment request 156 to the BSC 130. The BSC 130 then reserves radio resources for the MS 135. An assignment complete message 159 is sent back to the MSC 110 from the BSC 130. After completion of the connection between the MS 135 and the BSC 130, a connect message 161 is sent from the MS 135 to the BSC 130. The BSC 130 then forwards the connect message 161 as a connect message 162 to the MSC 110.

After the radio resources have been properly acquired, the MSC 110 establishes a connection with the IWF 120 for adapting the circuit switching incoming call to be delivered to the MS 135. The MSC 110 establishes a first link on the cellular network 200 side by sending a call setup message 170 to the IWF 120. The MSC 110 then waits for the acknowledge message 171 and for the answer message 172 therefrom. The MSC 110 then establishes a second link on the PSTN 140 side by sending a call setup message 174 to the IWF 120. In response thereto, the IWF 120 responds with an acknowledge message 175 and an answer message 177. The answer message 177 is then forwarded by the MSC 110 to the PSTN 140 as an answer message 178. Data transfer 180 can now occur between the PSTN 140 and the MS 135.

The hereinabove method involves a connection with the destination MS 135 as soon as the MSC 110 receives the data call 150 from the PSTN 140. Such an approach is inefficient, since radio resources are reserved between the BSC 130 and the MS 135 from the beginning and before other negotiations with the IWF 120. Such method is non-linear, and causes an inadequate use of resources.

Therefore, it is an objective of this invention to provide an improved delivery scheme for incoming data calls from the PSTN to mobile stations.

### SUMMARY OF THE INVENTION

The present invention relates to a method for delivering an incoming data call from a Public Switched Telephone Network (PSTN) to a Mobile Station (MS). A Mobile Switching Center (MSC) first receives an incoming call and initiates a call setup procedure with an Interworking Function (IWF). The IWF adapts the data call for a cellular network and completes the call setup procedure with the MSC. The MSC then initiates a connection with a Base Station Controller (BSC) currently serving the MS. After the connection is completed, the PSTN is informed and data transfer with the MS can be initiated.

The present invention is also further directed to an MSC. The MSC receives an incoming call with an input/output module. The MSC then uses a data call delivery module for establishing a call setup procedure with an IWF prior to connecting the incoming data call with a targeted MS.

### BRIEF DESCRIPTION OF THE DRAWINGS

A more complete understanding of the present invention may be had by reference to the following Detailed Description when taken in conjunction with the accompanying drawings wherein:

FIG. 1 is a signal flow chart of data call delivery from a Public Switched Telephone Network (PSTN) to a Mobile Station (MS) according to prior art;

FIG. 2A is a schematic representation of the nodes involved in data call delivery from a Public Switched Telephone Network (PSTN) to a Mobile Station (MS);

FIG. 2B is a schematic representation of the nodes involved in data call delivery from a Public Switched Telephone Network (PSTN) to a Mobile Station (MS) where an interface is internally included at the Base Station Controller;

FIG. 3 is a signal flow chart of data call delivery from a Public Switched Telephone Network (PSTN) to a Mobile Station (MS) in accordance with the present invention;

FIG. 4 is a schematic representation of nodes involved in data call delivery from a Public Switched Telephone Network (PSTN) to a Mobile Station (MS) in case of inter MSC handoff; and

FIG. 5 is a modular representation of an M SC node.

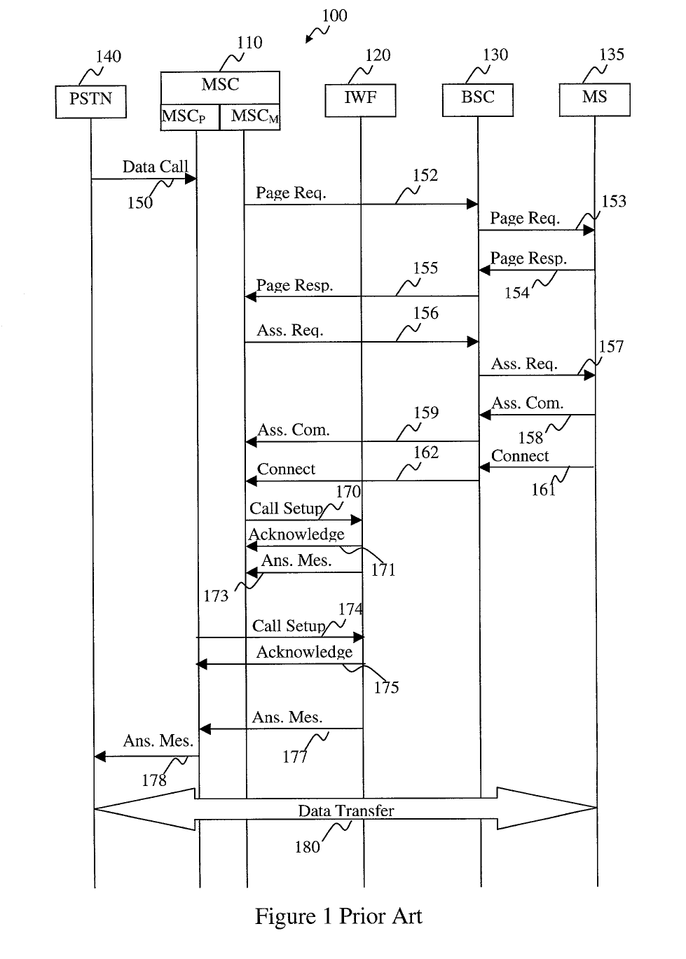

### DETAILED DESCRIPTION OF THE PREFERRED EMBODIMENTS

The present invention provides an improved method for delivering data calls coming from a Public Switched Telephone Network (PSTN) to mobile stations. Thus, it solves the problems presented earlier of inadequate use of resources and of non-linear resource allocation during the delivery of data calls from the PSTN through a cellular network to a mobile station.

In the context of this invention, a data call represents any data exchange between the PSTN and a mobile station. The data call coming from the PSTN does not mean the data is only exchanged in one direction. For example, after the connection is initiated, the mobile station is able to both send and receive data. A fax call can also be delivered to mobile stations with this invention.

The PSTN is well know in the art and represents a public telephone system. The PSTN uses the circuit switching method for interconnecting subscribers. The PSTN is used for voice calls as well as data calls.

The cellular network is a wireless network that uses radio frequencies to interconnect subscribers. The area covered by the cellular network is divided into smaller areas called cells. Each cell is served by a base station, which includes at least one antenna handling radio communication with one or more mobile stations. A Base Station Controller (BSC) controls one or more base stations. Each BSC is connected to a Mobile Switching Center (MSC) handling the calls inside the cellular network. More than one BSCs are usually connected to a MSC. Some MSCs also handle the calls connecting the PSTN to the cellular network.

Mobile stations represent any wireless device connected to the cellular network. For example, a mobile station can be a regular wireless telephone, a wireless fax machine, a computer with a wireless network card or a Personal Digital Assistant (PDA) with wireless network capabilities.

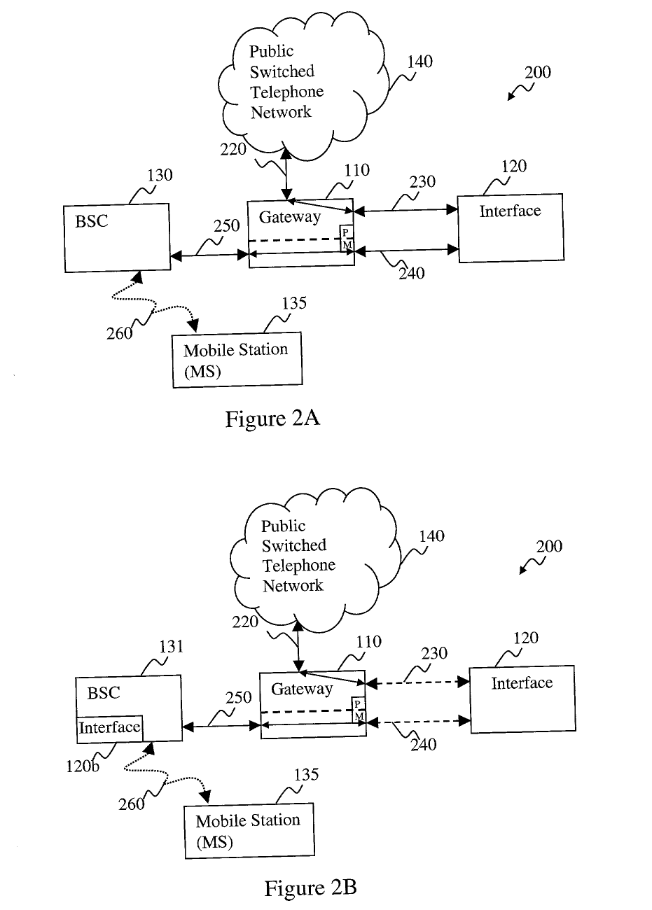

Reference is now made to FIG. 2A, which shows a schematic representation of nodes involved in data call delivery. The data call delivery takes place from the Public Switched Telephone Network (PSTN) 140 to a Mobile Station (MS) 135 through a cellular network 200. The cellular network 200 comprises a gateway 110, an interface 120 and a Base Station Controller (BSC) 130. It should be noted that only one BSC 130, one MS 135, one interface 120 and one gateway 110 have been shown for clarity reasons, but the cellular network 200 usually comprises several such nodes. The cellular network 200 also comprises one or more base stations (not shown) handling radio exchanges with one or more MS 135.

The PSTN 140 uses different parameters than the cellular network 200. The adaptation from one network to the other is done at the interface node 120. For doing so, the gateway 110 first receives a data call (not shown) from the PSTN 140 over a connection 220 between the gateway 110 and the PSTN 140. The connection 220 could be, for example, a wired bidirectional link and could implicate numerous other nodes not shown for clarity purposes. In accordance with the present invention, the gateway 110 initiates a call setup procedure with the interface 120 by first connecting the data call with the interface 120 via a first bidirectional path 230. At this point, the connection still uses only the circuit switching method. The interface 120 then adapts the data call for the cellular network 200 and opens a second bidirectional path 240 to the gateway 110. The gateway 110 then initiates a connection with the BSC and routes the data call to the MS 135 as an ordinary call, enabling the data transfer with the MS 135 to be initiated. The two paths used in the gateway 110 are illustrated with the “P” letter on the PSTN side and with the “M” letter on the cellular network side.

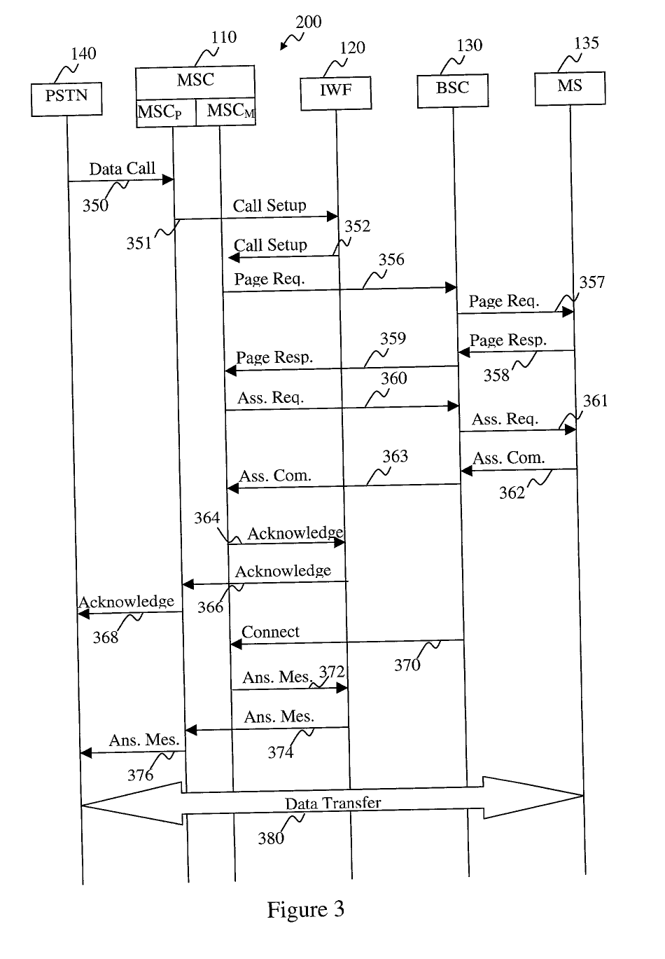

Reference is now made concurrently to FIGS. 2A and 3, wherein FIG. 3 shows a signal flow chart of a data call delivery in accordance with the present invention. Hereinafter, the gateway is also referred as a Mobile Switching Center (MSC) 110. The interface is also referred to as an Interworking Function (IWF) 120. The data call 350 originating from the PSTN 140 is received at the MSC 110. The MSC 110, after identifying the incoming call type and destination, associates a first Service Option (SO) (not shown) to the data call 350. It should be noted that the SO is not necessarily assigned at the MSC 110. The SO concurrently specifies the media (ex.: data, fax, voice etc.) and the media variant (ex.: data rate set 1, data rate set 2 etc.). The MSC 110 also uses a Temporary Location Directory Number (TLDN) (not shown) enabling the data call 350 to be delivered by the cellular network 200. The TLDN is a temporary number used to route a call to the mobile subscriber and is only used for the duration of the call setup procedure. In some other configurations, the TLDN is replaced with another number such as the destination number.

The MSC 110 then initiates a call setup procedure with the IWF 120. The initiation of the call setup procedure consists mainly in sending a call setup message 351 to the IWF 120 via the first path 230 between the IWF 120 and the MSC 110. The call setup message 351 contains a phone number identifying the source of the data call 350, the first SO and the TLDN as the destination of the data call 350. The IWF 120 can reply to the call setup message 351 with a call proceeding message (not shown). The call proceeding message is sent when the IWF 120 is unable to fulfill the call setup request 351 immediately and to inform the MSC 110 that the request will still be processed as soon as possible. The IWF 120 then adapts the data call 350 for the cellular network. The adaptation is performed through steps comprising data rate adjustment between the PSTN 140 link rate and the air interface rate of the cellular network 200, as known in the art.

The IWF 120 then sends a call setup message 352 to the MSC 110 via the second path 240. The connect message 352 also contains the phone number identifying the source of the data call 350, the first SO and the TLDN as the destination of the data call 350. After reception of the call setup message 352 at the MSC 110, the call setup procedure is completed. After the call setup procedure is completed between the MSC 110 and the IWF 120, the MSC 110 releases the TLDN and initiates a connection with the BSC 130 currently serving the MS 135. In order to do so, the MSC 110 sends a page request 356 containing the first SO to the BSC 130. The BSC 130, following the page request 356, sends a page request 357 to locate the MS 135 in its served area. The MS 135 responds with a page response 358. The BSC 130 then sends a page response 359 to the MSC 110. The page response 359 may contain a second SO (not shown) if the MS 135 was unable to fulfill the needs of the first SO. The IWF 120 must be updated with the new SO information in order to adapt the data call 350 accordingly. The update process involves sending a Call Progress message (not shown) from the MSC 110 to the IWF 120.

After the reception of the page response 359, the MSC 110 sends an assignment request 360 to the BSC 130. The assignment request 360 contains the latest SO associated with the data call 350. This SO can either be the first SO or the second SO. The BSC 130 then reserves radio resources for the MS 135. The MSC 110 then waits for the BSC 130 to answer with an assignment complete message 363. The assignment complete message 363 may contain a third SO (not shown) if the MS 135 was unable to fulfill the needs of the previous SO. The IWF 120 must be updated with the new SO information in order to adapt the data call 350 accordingly. The update process involves sending a Call Progress message (not shown) from the MSC 110 to the IWF 120.

The MSC 110 then sends an acknowledge message 364 to the IWF via the second path 240 and waits for the IWF 120 to forward an acknowledge message 366 on the first path 230. The MSC 110 then informs the PSTN 140 by forwarding an acknowledge message 368 to the PSTN 140 via the connection 220.

The BSC 130 initiates the completion of the connection procedure with the MS 135 by sending a connect message 370. The connect message 370 can be sent, if desired, as early as the BSC 130 sends an assignment complete message 363. After receiving an answer message 372 from the MSC 110 on the second path, the IWF 120 completes the connection procedure by sending an answer message 374 to the MSC 110 on the first path. When both the connect message 370 and the answer message 374 are received, the MSC 110 informs the PSTN 140 by forwarding an answer message 376 thereto. The data transfer 380 can now occur.

Thus, it can be appreciated that in accordance with the present invention, the connection between the BSC 130 and the MS 135, which requires radio resources, is only performed after the completion of the call setup procedure between the MSC 110 and the IWF 120. The present invention thus ensures sequential allocation of resources for the delivery of data calls.

Reference is now made to FIGS. 2B and 3 wherein FIG. 2B shows a schematic representation of the nodes involved in data call delivery where an interface 120b is internally included at the BSC 130. The difference between FIGS. 2A and 2B consists of having an interface 120b connected to a BSC 131. The interface 120b fulfills the same functions than the interface 120. It should be noted that only one BSC 131, but the cellular network 200 usually comprises several such nodes. Both BSC 131 and BSC 130 are usually represented in the cellular network 200.

The following scheme makes better use of the equipment in the cellular network 200 where both kinds of BSCs are present. In such a case, the interface 120b connected to the BSC 131 is used instead of the interface 120. After receiving the data call 350, the gateway 110 identifies the BSC currently serving the MS 135. The identification can be done by sending an extra page request (not shown) and by receiving at the gateway 110 an extra page response (not shown) from the BSC currently serving the MS 135.

As a variant to the identification with the extra page message, the gateway 110 can add information in the MS profile. The added information associates each MS 135 with a BSC. This information is updated each time the MS 135 moves from one BSC to another. Therefore, adding the information in the MS profile eliminates the need for an extra page message.

The gateway 110 than verifies if the BSC currently serving the MS 135 is equipped with an interface 120b. If the BSC is equipped with the interface 120b, the data call 350 is sent on the network as an ordinary call. The BSC 131 then takes care of establishing the appropriate connection with the MS 135 for the data transfer 380. If the BSC currently serving the MS 135 is not equipped with the interface 120b, the method presented at FIGS. 2A and 3 is used.

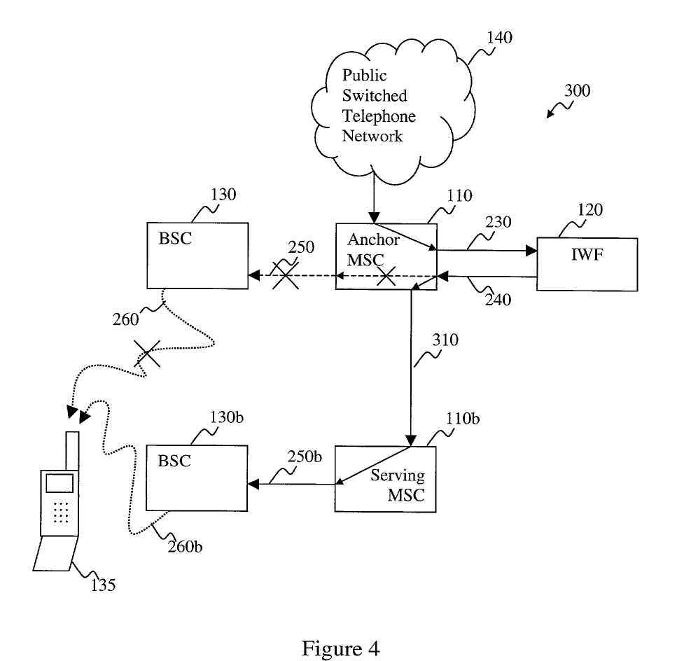

Reference is now made to FIG. 4, which shows a schematic representation of the nodes involved in data call delivery in case of inter MSC handoff. The important aspect of the particular handoff case is that the IWF 120 remains attached to the first serving MSC 110 called the Anchor MSC. The Anchor MSC 110 initiates a handoff process according to certain triggers comprising the transmission quality. The handoff is done to let another MSC serve the MS 135. The other MSC is called a Serving MSC 110b. The connections 250 and 260 are released after the establishment of a connection 250b with the MS 135 by a Serving MSC 110b and a connection 310 between the Anchor MSC 110 and the Serving MSC 110b.

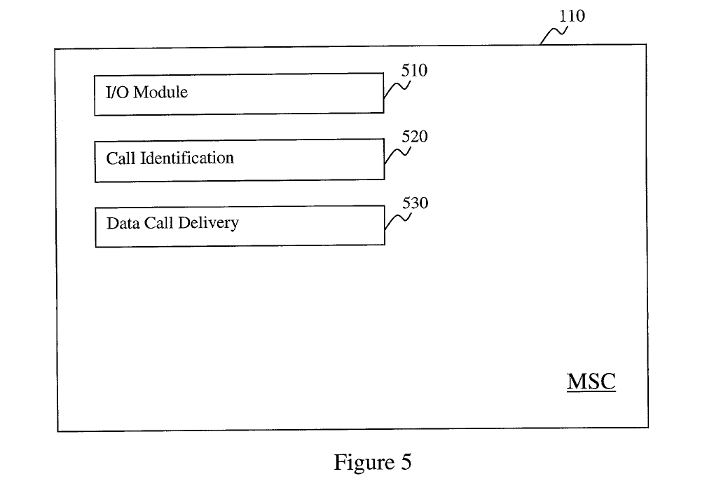

Reference is now made to FIG. 5, which shows a modular representation of the MSC node. The MSC 110 comprises an input/output module 510, a call identification module 520 and a data call delivery module 530. The input/output module is used for receiving and transmitting to other nodes. More precisely, the input/output module receives an incoming call. The incoming call is then passed to the call identification module for further treatment. The call identification module 530 identifies the incoming call as a data call 350. The call identification module also identifies the destination of the data call 350. The data call 350 is then passed from the call identification module to the data call delivery module. The data call delivery module 520 takes care of the steps to connect the data call 350 to the MS 135. The data call delivery module 520 establishes the call setup procedure with the IWF 120 prior to connecting the data call 350 with the targeted MS 135.

What is claimed is:

1. A method for delivering an incoming data call from a Public Switched Telephone Network (PSTN) to a Mobile Station (MS), the method comprising steps of:
receiving at a Mobile Switching Center (MSC) the incoming call;
initiating a call setup procedure at the MSC with an Interworking Function (IWF);
adapting at the IWF the data call for a cellular network and completing the call setup procedure with the MSC;
initiating at the MSC a connection with a Base Station Controller (BSC) currently serving the MS;
informing the PSTN upon completion of the connection; and
initiating data transfer with the MS.

2. The method of claim 1 wherein the step of receiving at the MSC the incoming call comprises steps of:
identifying a source of the incoming call;
identifying a destination for the incoming call; and
associating the incoming call with a first Service Option (SO).

3. The method of claims 2 where the step of identifying a destination of the incoming call further comprises using a Temporary Location Directory Number (TLDN).

4. The method of claim 1 wherein the step of initiating at the MSC the call setup procedure comprises sending a call setup message to the IWF, the call setup message comprising the identification of the source of the incoming call, the identification of the destination of the incoming call and the associated first Service Option (SO).

5. The method of claims 4 where the identification of the destination of the incoming call is a Temporary Location Directory Number (TLDN).

6. The method of claim 1 wherein the step of adapting the data call for a cellular network and completing the call setup procedure at the IWF comprises steps of:
adjusting the data rate from the PSTN link rate to the cellular network air interface rate; and
sending a call setup message to the MSC, the call setup message further comprising:
the identification of the source of the incoming call;
the identification of the destination of the incoming call; and
the associated first Service Option (SO).

7. The method of claims 6 where the identification of the destination of the incoming call is a Temporary Location Directory Number (TLDN).

8. The method of claim 1 wherein the step of initiating a connection with the Base Station Controller (BSC) currently serving the MS comprises steps of:
sending at the MSC a page request to the BSC currently serving the MS, the page request further comprising the associated first Service Option (SO);
upon receipt at the MSC of a page response from the BSC currently serving the MS, sending an assignment request message to the BSC currently serving the MS;
upon receipt at the MSC of an assignment complete message from the BSC currently serving the MS, forwarding an acknowledge message to the IWF;
upon receipt at the IWF of the acknowledge message from the MSC, forwarding the acknowledge message back to the MSC and sending an answer message to the MSC;
upon receipt at the MSC of the acknowledge message from the IWF, forwarding the acknowledge message to the PSTN; and
upon receipt at the MSC of a connect message from the BSC currently serving the MS and of the answer message from the IWF, sending an answer message to the PSTN.

9. The method of claim 8 wherein after the step of sending at the MSC a page request to BSC currently serving the MS, the method further comprises steps of:
identifying a second SO used by the MS; and
updating the SO information by sending from the MSC a Call Progress message to the IWF.

10. The method of claim 8 wherein assignment request message further comprises an associated SO.

11. The method of claim 8 wherein after the step of sending at the MSC an assignment request to BSC currently serving the MS, the method further comprises steps of:
identifying a third SO used by the MS; and
updating the SO information by sending from the MSC a Call Progress message to the IWF.

12. A Mobile Switching Center (MSC), comprising:
an input/output module for receiving an incoming call; and
a data call delivery module for establishing a call setup procedure with an Interworking Function (IWF) prior to connecting the incoming data call with a targeted Mobile Station (MS).

13. The MSC of claim 12 further comprises a call identification module for identifying a destination for the incoming call.

14. The MSC of claim 12 wherein the data call delivery module further:
uses a Temporary Location Directory Number (TLDN); and
associates the incoming call with a first Service Option (SO).

15. The MSC of claim 12 wherein the data call delivery module further:
establishes a call setup procedure, the call setup procedure comprises sending a call setup message to the IWF, the call setup message comprising:
the identification of the source of the incoming call;
the identification of destination of the incoming call; and
the associated first Service Option (SO);
receives a call setup message from the IWF;
sends a page request to a Base Station Controller (BSC) currently serving the MS, the page request further comprising the associated first SO;
receives a page response from the BSC currently serving the MS;
sends an assignment request message to the BSC currently serving the MS;
receives an assignment complete message from the BSC currently serving the MS;
sends an acknowledge message to the IWF;
receives the acknowledge message from the IWF;
forwards the acknowledge message to the PSTN;
receives a connect message from the BSC currently serving the MS;
sends an answer message to the IWF;
receives an answer message from the IWF; and
forwards the answer message to the PSTN.

16. The MSC of claim 15 wherein the data call delivery module following the reception of a page response from the BSC currently serving the MS further verifies the SO information, the verification comprising steps of:
identifying a second SO used by the MS; and
updating the SO information by sending a Call Progress message to the IWF.

17. The MSC of claim 15 wherein the data call delivery module following the reception of an assignment complete message from the BSC currently serving the MS further verifies the SO information, the verification comprising steps of:
identifying a second SO used by the MS; and
updating the SO information by sending a Call Progress message to the IWF.
